(19) United States
(12) Patent Application Publication
(10) Pub. No.: US 2011/0023734 A1
(43) Pub. Date: Feb. 3, 2011

(54) Transferring Printed and/or Embossed Structures onto a Continuous Film

(75) Inventor: Lars Hoffmann, Freising (DE)

Correspondence Address: THE WEBB LAW FIRM, P.C., 700 KOPPERS BUILDING, 436 SEVENTH AVENUE, PITTSBURGH, PA, 15219, US

(73) Assignee: GIESECKE & DEVRIENT GMBH, München (DE)

(21) Appl. No.: 12/810,446

(22) PCT Filed: Dec. 17, 2008
(86) PCT No.: PCT/EP08/10745

§ 371 Date: Sep. 23, 2010

(30) Foreign Application Priority Data
Dec. 27, 2007 (DE) 10 2007 063 277.2

(51) Int. Cl. B31F 1/07

(52) U.S. Cl. 101/23; 101/32

(57) ABSTRACT

The present invention relates to an apparatus and a method for transferring print and/or embossing patterns to a security element with a printing or embossing cylinder (3) and a counter-pressure cylinder (5). The security element consists of at least one substrate in the form of an endless foil that is light-transmitting in at least some regions (1), the endless foil (1) running between the printing or embossing cylinder (3) and the counter-pressure cylinder (5).

According to the present invention, in the running direction of the endless foil (1), before the printing or embossing cylinder (3) is arranged at least one pivot roller (4) that overstretches the endless foil (1) to one side. This creates an inclination of the endless foil (1) in relation to the axis of the printing or embossing cylinder (3).

The present invention relates to an apparatus and a method for transferring print and/or embossing patterns to a security element with a printing or embossing cylinder and a counter-pressure cylinder. The security element consists of at least one substrate in the form of an endless foil that is light-transmitting in at least some regions, the endless foil running between the printing or embossing cylinder and the counter-pressure cylinder.

Most printing processes, such as intaglio printing, offset printing, relief printing and rotation screen printing, work with a printing or embossing unit consisting of a printing or embossing cylinder and a counter-pressure cylinder that is also referred to as an impression roller. The substrate to be printed on is guided between the printing or embossing cylinder and the counter-pressure cylinder. Here, due to the mechanical pressure between the two cylinders, an inking or an embossing pattern is transferred to the substrate. In intaglio printing, a special form of gravure printing, a combination of printing and embossing is also possible, since here, due to the enormously high pressure that occurs between the printing cylinder and the counter-pressure cylinder in this printing process, not only is the substrate inked, but in addition, the substrate is also deformed in this region. The inking and the embossing are arranged congruently.

The substrate can be fed to the printing or embossing unit in individual sheets that are piled up on a stack. Alternatively, the substrate can be wound up as a quasi-endless band on a roll. Here, if the substrate consists of a foil, then this endless band is referred to as an endless foil. The endless foil thus exhibits, in contrast to a sheet-shaped foil, a length that is substantially larger than its width. An endless foil is, naturally, not infinitely, but rather finitely long, but it is so long that it is wound up on the roll for transport and processing purposes. Of course it is also possible to feed the foil to the printing unit directly after its manufacturing process, such that the foil can be processed as a continuous web and without mechanical cutting to length.

Such endless foils are applied in the manufacture of security elements for value or security documents, such as banknotes, identity cards, passports, certificates, and credit or debit cards. Here, the endless foil is printed on and/or embossed, and if applicable, provided with further lacquer or plastic layers and applied to a substrate or introduced into in a substrate. Here, this substrate consists especially of paper.

From DE 10 2005 062 132 A1, for example, is known a security element in the form of threads and foils for security papers, value documents and the like that exhibits a micro-optical moiré magnification arrangement. This moiré magnification arrangement consists of a motif image over which microfocusing elements are located. The motif image consists of a periodic or at least locally periodic arrangement of micromotif elements having motif elevations and motif spacings of 10 μm to 40 μm. The microfocusing elements are likewise arranged periodically or at least locally periodically. The micromotif elements are located in the focus plane of the microfocusing elements. Both elements are arranged in a regular grid. A magnification effect is created by a systematically set tilting of the two grids toward one another. The set tilting angle determines the magnification. The motif image is overprinted or imprinted on a substrate that preferably consists of a foil that is light-transmitting in at least some regions. The microfocusing elements are embossed in a lacquer layer on the second foil side. The substrate foil of the micropattern elements and of the microfocusing elements forms the spacer that places the micropattern elements in the focus plane of the microfocusing elements to produce, in this way, a sharp image.

In addition to the magnification effect of the motifs of the motif image, an apparent movement of the magnified motifs relative to the background occurs, with both vertical and horizontal movements being able to occur. Here, the motifs apparently float against the background and move as soon as the security element is tilted about an axis.

The desired magnification effect comes about depending on the chosen geometric arrangement of the two planes of the microfocusing elements and of the motif image to one another. Here, the screen ruling of the microfocusing elements and of the motif image, as well as the angular position of the main axes of the planes of both arrays, are set accordingly to one another, the offset between the main axes being only in a very narrow range from 0.1° to 0.5°.

The position of the main axes of the two planes to one another must be kept exactly at a precisely defined angle during the entire process of manufacturing the security element. For example, an angular offset occurring during the manufacture of the security element can shift the position of the two planes to one another in an undesired manner, for example orient the planes that were previously arranged obliquely to one another parallel to one another again, such that the magnification and the movement direction that is visible in the magnified motif is altered. These deviations are caused by imprecisions in the manufacture of the printing or embossing unit for the micropattern elements and the microfocusing elements, as well as an undesired twisting of the substrate foil when imprinting the microfocusing elements or also when transporting the foil prior to overprinting/imprinting the micropattern elements.

Since the angles required for setting the desired magnification are very small, at 0.1° to 0.5° the deviations from the specifications that occur by default in the manufacture of the printing or embossing roller and the tilting of the foil that normally occurs in web printing when printing/embossing effect, through lateral overstretching, an optically clearly visible change in the magnification. This made the production of a foil having a constant magnification factor impossible.

It is the object of the present invention to propose an apparatus and a method of manufacturing security elements that solves the problems of the background art.

This object is solved by the features of the independent claims. Developments of the present invention are the subject of the dependent claims.

According to the present invention, in the running direction of the endless foil, before the printing or embossing cylinder is arranged at least one pivot roller that overstretches the endless foil to one side. This creates an inclination of the endless foil in relation to the axis of the printing cylinder or of the embossing cylinder.

The advantage of the systematic inclination of the foil consists in that the deviations that, in the production process, occur in the tilting angle of the micropattern element plane and the microfocusing element plane can be compensated for.

For one thing, this creates the possibility to cancel out, by a firmly specified tilt of the pivot roller, the deviations that occur in the manufacturing process of the printing or embossing roller.

For another, it is also possible to remedy fluctuations in the magnification due to lateral overstretching of the foil in preparatory operations by actively controlling the pivot roller. For this, behind the printing or embossing unit in which the micropattern element is applied is installed a camera that facilitates for the operator the optical observation of the image produced in the printing process. Any change that may occur in the magnification compared with a target image that is present can thus be counteracted by actuating the pivot roller. Since, in a controlled web printing, lateral overstretches of the foil do not occur jerkily, but rather build up continually over the running length and, to some extent, also remain constant, the web observation behind the printing or embossing unit facilitates a sufficiently quick reaction. Thus, particularly advantageously, a basis for a constant production is created.

A particular advantage of the present invention is thus that, in the manufacture of the printing or embossing roller, the exact setting of the angular orientation can be omitted, since this occurs only during the printing on and/or embossing of the endless foil by means of the pivot roller. Deviations from the exact setting of the angular orientation of the micropattern array, which are unavoidable due to the small angle, can be canceled out. The production tolerance at tool manufacture is thus increased.

Furthermore, with the aid of the pivot roller, also a desired magnification of the motif of the motif image can be achieved. The printing or embossing rollers used exhibit no tilting of the grid planes of the micropattern elements and of the microfocusing elements. The tilting is achieved by the pivot roller alone. The advantage of this method is, among other things, producing different magnifications of the motifs of the motif image with one and the same printing or embossing unit, for which a new or additional printing or embossing unit would otherwise be required.

In all of the embodiments mentioned, similar to direct overprinting, the micropattern elements are applied to the substrate foil that, upon running into the printing or embossing unit, is systematically tilted by the pivot roller through elastic overstretching. In this way is created a tilt of the micropattern elements to the approaching foil, which bears the microfocusing elements on the reverse. The tilt serves, as described above, the setting and readjustment of the magnification of the moiré magnification arrangement.

If an embossing lacquer layer is applied on the endless foil, the embossing cylinder transfers embossing patterns to the embossing lacquer layer. This can involve a thermoplastic embossing process or embossing in a radiation cross-linking lacquer. The curing of the embossing patterns preferably occurs in the region in which the endless foil loops around the printing or embossing cylinder, by means of electron beams or by means of UV radiation. As radiation cross-linking lacquers, UV-curing lacquers, for example, are used that are structured as radicals and provided with photoinitiators, and that are excited in the long-wave UV or in the short-wave visible range with wavelengths from 400 nm to 450 nm.

The pivot roller is particularly preferably set obliquely against the axis of the following printing or embossing cylinder in such a way that the endless foil exhibits a lateral offset of 0.01% to 0.65% with respect to the foil width. Thus, for a foil width of 810 mm, a lateral offset of 0.1 mm to 5 mm is created.

The inclination of the pivot roller occurs particularly preferably in that the pivot roller is mounted foldably or rotatably at one end, for example by a hinged or ball joint. At its other end, the pivot roller is slidably mounted, with this end being moved, for example, by a shaft, hydraulics, pneumatics or a servomotor. Alternatively, it is also possible that the pivot roller is slidably mounted at both ends, such that arbitrary orientations of the pivot rollers in space with respect to the printing or embossing cylinder can be set. In this case, both ends are each moved by a shaft, hydraulics, pneumatics or a servomotor, or another drive.

Advantageously, also multiple pivot rollers can be arranged behind one another. In this way, the achievable tilt of the foil can be increased in individual cases. Upon rotation of an individual pivot roller, for a strong tilt, the danger of wrinkling in the foil results, which can be reduced by a tilt executed in multiple stages.

The design of the pivot rollers with respect to the setting possibilities, the reproducibility and the setting accuracy is adapted for the appropriate application with mechanical components and read-out possibilities. Here, the setting occurs with sufficient precision, for example via motor-driven or hydraulically/pneumatically driven fine-thread shafts or pistons. The positioning by the operator is to be performed reproducibly through a monitored feed of the actuator. In this way, depending on the foil type, different tilts can be achieved with the same adjustment from the zero position, since the mechanical stiffness and the slippage of different foils on the adjustment roller is different.

The exact determination of the target setting of the pivot roller occurs, for example, with the aid of an observation camera behind the printing or embossing unit. Also a purely manual mechanical setting of the pivot roller with hand wheels that bear an angle indicator is possible in this way. Similar applies when a hydraulic adjustment of the pivot roller is used. The adjustment of the hydraulic sliding of the pivot roller occurs through the operator, who uses the image on the observation camera for orientation.

A particular advantage of the present invention is thus that it is possible to systematically react to an undesired and changing lateral offset in the endless foil already during the printing and/or embossing process. Here, active and/or passive control systems regulate the counter-stretching, required in each case, of the endless foil by adjusting the pivot roller.

In one of the above-mentioned embodiments, the micromotif elements of the motif image on the printing and/or embossing cylinder are oriented vertically to the axis of the printing and/or embossing cylinder. In the creation of embossing cylinders and intaglio printing cylinders, a rectangular orientation of print motifs or micromotif elements corresponds to the commonly used standard, such that, particularly advantageously, common software programs and the usual approach to manufacturing embossing cylinders can be retained. Thus, fitting errors due to otherwise required software changes or due to required mechanical tilting when recombining can be avoided.

When the pivot roller is tilted downward in relation to the running direction of the endless foil, an overstretching of the endless foil to the right in relation to the running direction of the endless foil occurs. If, in contrast, the pivot roller is tilted upward, an overstretching of the endless foil to the left occurs.

Finally, if the pivot roller is not tilted, no overstretching of the endless foil occurs.

To finish, after the printing and/or embossing cylinder, the endless foil is wound up on a roll, in the running direction of the endless foil, and guided to its further processing. Here, the endless foil can be unwound again, cut into thin threads and in turn wound up on a roll. Alternatively, the endless foil can, of course, also be cut and stacked directly following the printing and/or embossing process such that further processing as foil sheets is possible.

In the above-mentioned moiré magnification arrangements, the viewing angles for the visual perceptibility and the shifts in the views of the micromotif elements are coordinated with one another in such a way that, for the viewer, a motif depiction is created that moves substantially vertically to the tilt axis when the security element is tilted and that is referred to as the orthoparallax. It contradicts the usual movement behavior in three-dimensional space and thus exhibits a high attention and recognition value. Here, an advantage of the present invention is that this effect of the orthoparallax is not disrupted. Any slight changes still present in the orientation of the movement direction with respect to the tilt axis are hardly noticeable in the finished moiré magnification arrangement. In contrast to this, a motif depiction that, for the viewer, moves substantially parallel to the tilt axis when the security element is tilted is referred to as the parallax.

Particularly advantageously, at manufacture of the moiré magnifier, an orientation of the orthoparallax or also of the parallax can be set between the periodic or locally periodic arrangement of the microfocusing elements and the micromotif elements through the overstretching of the endless foil. Here, the stamping of the fine patterns of the moiré magnifier is not disrupted, since said stamping is determined by the directly overlying counter-pressure roller that prevents slipping of the endless foil on the embossing tool. The micromotif elements of such embodiments exhibit magnitudes of 5 μm to 100 μm, and preferably have a motif size of 15 μm to 40 μm. The associated microfocusing elements are applied, for example, as spherical cylinder lenses having a radius of curvature of 5 μm to 50 μm, preferably of 10 μm to 35 μm.

The described invention also facilitates conscious change in the movement direction of the magnified motifs in identical designs so as to facilitate a simple differentiation between different products having the same design elements. Through the systematic change in the angular orientation of the micromotif array to the array of the microfocusing elements, it is possible to set the preferred movement direction of the visible magnified moiré magnifier. In this way, it is possible to orient the main movement direction horizontally, for example. This orientation is the most favorable one for viewing; in the background art, only a movement in a preferred direction that is on a slant to the horizontal is specified. The present invention now facilitates a systematic setting of the main movement direction and thus an improvement in the differentiation of different products.

Furthermore, through the described setting possibility, in the same magnified motif, a moiré magnifier design that is distinguishable with the eye can be achieved that is conceivable for use in different denominations of a currency. In this way, a differentiation between three values can occur through different movement directions, for example through a movement diagonally from top left to bottom right, or horizontally, or diagonally from bottom left to top right. Since, for micropattern foils, the die manufacture has a noticeable impact in terms of time and money, the variation possibility given represents an economical alternative for executing multiple denominations with the same motif and different movement directions.

The micromotif elements are preferably arranged in the form of microscopic patterns on a substrate composed of paper or of a second endless foil. If the micromotif elements are arranged on a substrate composed of a second endless foil, then, just like the first endless foil, also the second endless foil can be overstretched to one side. Due to the overstretching of the second endless foil, an inclination of the second endless foil in relation to the running direction of the second endless foil is also created, the second endless foil being embossed and/or printed on after the inclination of the second endless foil. Here, the second endless foil is overstretched by an appropriate further pivot roller having a tilting device, the pivot roller of the second endless foil being able to be tilted dependently or independently of the pivot roller of the first endless foil.

The security element is particularly preferably a patch, a security foil or a thread for a security document, such as a banknote, an identity card or a card. Here, a patch is an individual label-like element that is applied on the surface of the substrate; a security foil a foil strip that is applied on the surface of the substrate; and a thread a foil strip that is arranged completely or partially within the substrate.

The advantages of the present invention and different preferred embodiments of the present invention will be explained with reference to the following examples and supplementing drawings. In detail, depicted schematically are:

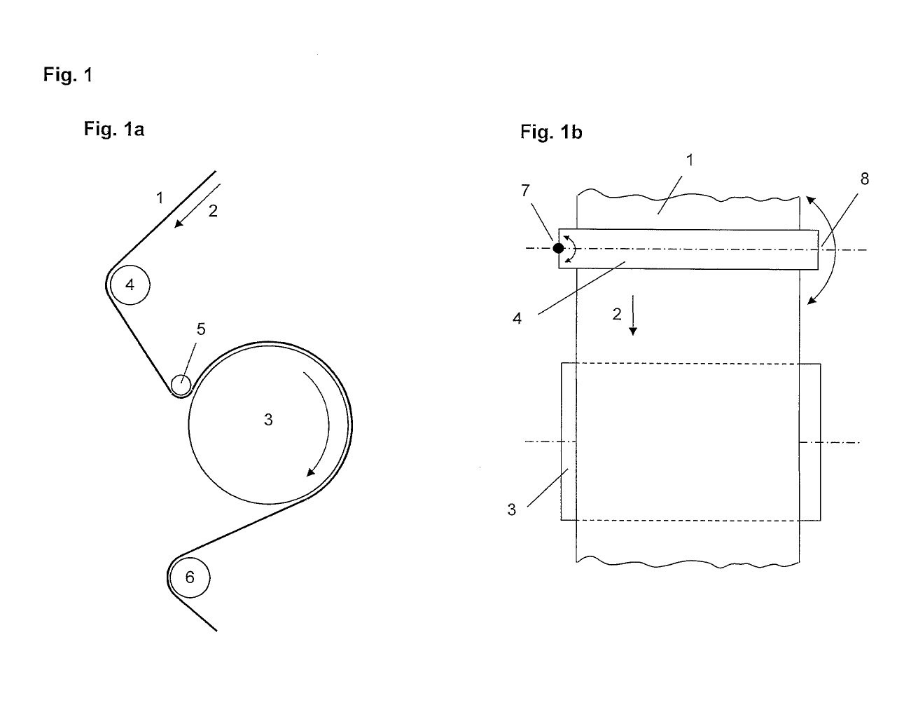

FIG. 1 an inventive embossing machine having an embossing tool and pivot roller, and here, in

FIG. 1a in side view,

FIG. 1b in top view,

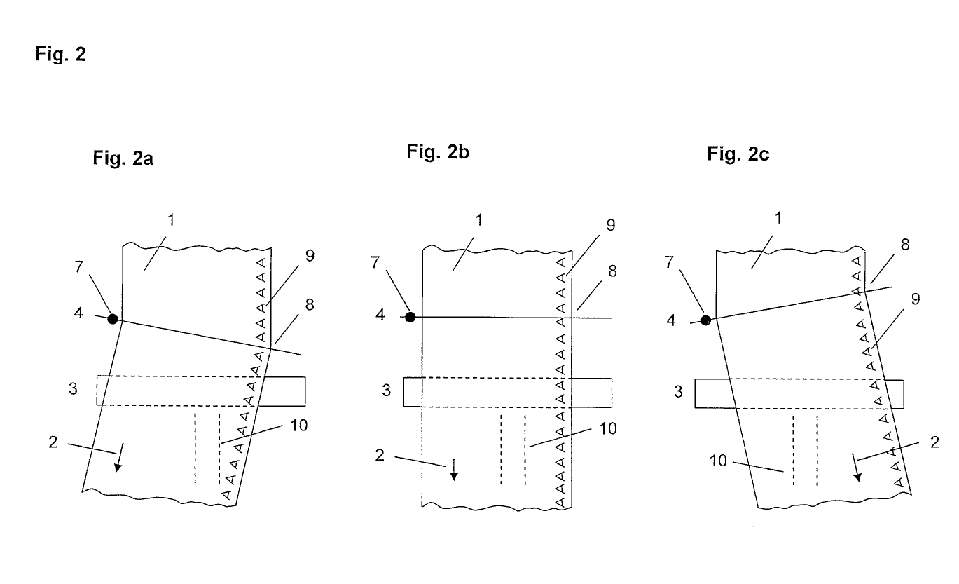

FIG. 2 the operating principle of an embossing machine according to the present invention, and here, in

FIG. 2a with the pivot roller tilted downward,

FIG. 2b without the pivot roller tilted,

FIG. 2c with the pivot roller tilted upward.

For the sake of better comprehensibility, the embodiments described in the following examples are reduced to the essential core information and the illustrations in the drawings are highly schematized and do not reflect the real conditions. Above all, the proportions shown in the figures do not correspond to the actual relationships and serve solely to improve clarity. In practical implementation, significantly more complex patterns or images in single- or multicolor printing can be used as a coating. The same applies for the embossing patterns. The pieces of information depicted in the following examples can likewise be replaced by any complex pieces of image or text information.

The examples depict preferred embodiments, to which, however, the present invention is in no way intended to be limited. In particular, the different exemplary embodiments are also not limited to use in the form described, but rather can also be combined with each other to increase the effects.

FIG. 1a shows, in side view, an embossing machine having an embossing tool in the form of an embossing cylinder 3 and a pivot roller 4. The embossing machine feeds an endless foil 1 in transport direction 2 over the pivot roller 4 to the embossing cylinder 3. Through a counter-pressure roller 5, the endless foil 1 is pressed against the embossing cylinder 3 in such a way that the patterns to be embossed are imaged on the endless foil 1.

The endless foil 1 loops around the embossing cylinder 3 in an angle range of about 230°, a curing of the endless foil 1 occurring in this range. Here, the endless foil is irradiated, for example with UV light, such that the embossing lacquer applied on foil is cured and the micropattern elements transferred in the embossing unit are thus firmly frozen in the embossing lacquer.

Following the embossing process, the endless foil 1 is guided to its further processing via an idler roller. In this way, the endless foil 1 can, for example, be wound up on a roll again, or be cut to length or cut off and stacked in the form of individual sheets.

According to FIG. 1b, the pivot roller 4 is mounted rotatably or pivotably on one side 7. The point 7 thus constitutes the joint about which the pivot roller 4 can be rotated or pivoted. On its other side 8, the pivot roller 4 is suspended slidably. Here, a hydraulic cylinder, a lever mechanism or a shaft, for example, engages at the suspension 8 and slides it in arbitrary spatial directions, for example upward or downward.

This pivoting of the pivot roller is illustrated schematically in FIG. 2. For a better overview, the pivot roller 4 is depicted as a line.

FIG. 2b shows the initial state, that is, the non-tilted pivot roller 4, whose rotation axis thus lies parallel to the rotation axis of the embossing cylinder 3. Embossing patterns 10 that are applied to the endless foil 1 by the embossing cylinder 3 are oriented parallel to a print motif 9.

If the pivot roller is tilted downward according to FIG. 2a, an overstretching of the endless foil to the right in relation to the running direction of the endless foil occurs. The angle of the overprint or of the imprint of the micromotif elements with respect to the microlens arrays on the foil reverse is rotated accordingly. A stronger magnification follows if, before the pivoting, the two periodic or at least locally periodic arrangements of micromotif elements and microfocusing elements were oriented parallel to one another.

Accordingly, if the pivot roller is tilted upward according to FIG. 2c, an overstretching of the endless foil to the left in relation to the running direction of the endless foil occurs.

1. An apparatus for transferring print and/or embossing patterns to a security element comprising of at least one substrate in the form of an endless foil that is light-transmitting in at least some regions, having a printing or embossing cylinder and an impression cylinder, with the endless foil miming between the printing or embossing cylinder and the impression cylinder, wherein, in the running direction of the endless foil, before the printing or embossing cylinder is arranged at least one pivot roller having a tilting device that overstretches the endless foil to one side such that an inclination of the endless foil in relation to the axis of the printing cylinder or of the embossing cylinder results in that the inclination of the pivot roller occurs in that the pivot roller is foldably or rotatably mounted at one end and slidably mounted at its other end, or is slidably mounted at both ends.

2. The apparatus according to claim 1, wherein an embossing lacquer layer is applied on the endless foil, and a curing station for curing the embossing lacquer layer is arranged in the region in which the endless foil loops around the printing or embossing cylinder.

3. The apparatus according to claim 2, wherein the curing of the endless foil occurs through ultraviolet radiation or through electron beams.

4. The apparatus according to claim 1, wherein, in the miming direction of the endless foil, after the printing or embossing cylinder, the endless foil is examined with the aid of an observation system and finally wound up.

5. The apparatus according to claim 1, wherein the pivot roller is set obliquely against the axis of the following printing or embossing cylinder in such a way that the endless foil exhibits a lateral offset of 0.01% to 0.65% in relation to the foil width.

6. The apparatus according to claim 5, wherein, for a foil width of 810 mm, a lateral offset of 0.1 mm to 5 mm is created.

7. The apparatus according to claim 1, wherein the pivot roller is guided by a hinged or ball joint at its foldably or rotatably mounted end, and a shaft, hydraulics, pneumatics or a servomotor slides the other end.

8. The apparatus according to claim 1, wherein a shaft, hydraulics, pneumatics or a servomotor moves one of the ends of the pivot roller in each case.

9. The apparatus according to claim 1, wherein the design of the pivot roller with respect to the setting possibilities, the reproducibility and the setting accuracy is adapted for the appropriate application with mechanical components and read-out possibilities, an exact positioning of the actuators occurring through regulated setting of the displacement paths, coupled with an indication of the displacement path moved, and the setting being able to be electronically calipered or read out on a mechanical measuring apparatus installed at the pivot roller.

10. The apparatus according to claim 1, wherein active and/or passive control systems regulate the counter-stretching of the endless foil, required in each case, by adjusting the pivot roller.

11. The apparatus according to claim 10, wherein an optical observation system installed behind the printing/embossing unit supports the active or passive control.

12. The apparatus according to claim 1, wherein motifs on the printing or embossing cylinder are oriented vertically to the axis of the printing or embossing cylinder.

13. The apparatus according to claim 1, wherein, when the pivot roller is tilted downward in relation to the running direction of the endless foil, an overstretching of the endless foil to the right in relation to the running direction of the endless foil occurs.

14. The apparatus according to claim 1, wherein, when the pivot roller is tilted upward in relation to the running direction of the endless foil, an overstretching of the endless foil to the left in relation to the running direction of the endless foil occurs.

15. The apparatus according to claim 1, wherein the security element is a patch, a security foil or a thread.

16. A method for printing on and/or embossing an at least monolayer security element composed of at least one substrate in the form of a first endless foil that is light-transmitting in at least some regions, wherein the first endless foil is overstretched to one side, which creates an inclination of the first endless foil in relation to the running direction of the first endless foil, and after the inclination of the first endless foil, the first endless foil is embossed and/or printed on.

17. The method according to claim 16, wherein a curing of the first endless foil occurs in the region in which the first endless foil is embossed and/or printed on.

18. The method according to claim 16 or 17, wherein the embossing patterns in and/or on the light-transmitting first endless foil form a micro-optical system consisting of an arrangement having a plurality of microfocusing elements that are present in a first grid on the first endless foil.

19. The method according to claim 18, wherein the arrangement is arranged over a further arrangement composed of micromotif elements in the form of microscopic patterns on a further substrate in such a way that, when viewed through the microfocusing elements of the first arrangement, the microscopic patterns of the further arrangement are seen magnified and/or exhibit an apparent movement when the security element is tilted.

20. The method according to claim 19, wherein the further substrate is formed from paper or a second endless foil.

21. The method according to claim 20, wherein, just like the first endless foil, the second endless foil is overstretched to one side, which creates an inclination of the second endless foil in relation to the running direction of the second endless foil, and after the inclination of the second endless foil, the second endless foil is embossed and/or printed on.

22. The method according to claim 19, wherein the viewing angles for the visual perceptibility and the displacements of the second arrangement are coordinated with one another in such a way that, for the viewer, when the security element is tilted, a depiction of the second arrangement that moves substantially parallel or vertical to the tilt axis is created, the so-called parallax or orthoparallax, and through the overstretching of the first substrate to one side, the exact orientation of the parallax or orthoparallax between the first arrangement and the second arrangement is set.

23. The method according to claim 18, wherein a substrate foil is arranged between the light-transmitting first endless foil and the further substrate.

24. The method according to claim 16, wherein, during the printing or embossing process, an undesired and changing lateral offset in the first and/or second endless foil is systematically responded to in order to ensure a constant magnification within a production roll.
